(19) United States
(12) Patent Application Publication
(10) Pub. No.: US 2018/0267535 A1
(43) Pub. Date: Sep. 20, 2018

(54) ARCHITECTURE FOR A DRIVING ASSISTANCE SYSTEM WITH CONDITIONAL AUTOMATION

(71) Applicant: VALEO Schalter und Sensoren GmbH, Bietigheim-Bissingen (DE)

(72) Inventors: Caroline Robert, Creteil (FR); Vanessa Picron, Creteil (FR); Michel Leeman, Creteil (FR)

(73) Assignee: VALEO Schalter und Sensoren GmbH, Bietigheim-Bissingen (DE)

(21) Appl. No.: 15/537,600

(22) PCT Filed: Jan. 4, 2016
(86) PCT No.: PCT/EP2016/050025

§ 371 Date: Jun. 19, 2017

(30) Foreign Application Priority Data
Jan. 5, 2015 (FR) 1500005

(51) Int. Cl. G05D 1/00; B60R 16/023; G05D 1/02; B60W 10/04; B60W 10/18; B60W 10/20; B60W 50/023; H04L 12/40; G06F 11/20

(52) U.S. Cl. CPC G05D 1/0077; B60R 16/0231; G05D 1/0257; G05D 1/0231; G05D 1/021; B60W 2050/0005; B60W 10/18; B60W 10/20; B60W 50/023; H04L 12/40; G06F 11/2015; B60W 10/04

(57) ABSTRACT

The invention concerns an architecture for a driving assistance system with conditional automation capable of controlling an automatic emergency stop of a vehicle, comprising: a set (2) of sensors of at least three different technologies for observing an area in front of a vehicle; a main computer (10) capable of receiving, via a first upstream data communication network, information from said set (2) of sensors, and of transmitting commands, via a first downstream communication network, to a first computer (3) of an engine control system, to a second computer (4) of a braking system and to a third computer (5) of a steering control system: a backup computer (11) capable of receiving, via a second upstream data communication network, information from said set of sensors in case of a failure relative to the main computer (10); a main power supply source linked to each computer; and a backup power supply source. The architecture comprises a second downstream communication network connecting only the backup computer (11) to said second computer (4) of the braking system for the transmission of commands, and the backup power supply source is connected only to the main computer (10), to the backup computer (11) and to the second computer (4) braking system.

The present invention relates generally to automotive vehicles equipped with automatic driving aid systems, and more precisely to so-called “conditional automation” systems.

Driving automation is advancing in order to address numerous issues such as safety, mobility, eco-driving, and driving accessibility for all. Today, it is possible to have a fully automated driverless vehicle, on dedicated zones. The same does not hold as regards projects for automated on-road vehicles for which numerous problems, in particular in the legal field and in the field of safety, remain to be solved before seeing such vehicles on sale. In particular, in the case of an automated on-road vehicle in the presence of a driver, the Vienna Convention enacts, in its Article 8.5, that the driver must at all times be able to control his vehicle.

The SAE (the acronym standing for Society of Automotive Engineers) automated on-road vehicle standards committee has recently published a new report giving a classification of automated driving levels, (“Taxonomy and Definitions for Terms Related to On-Road Motor Vehicle Automated Driving Systems”, Standard J3016, 16 Jan. 2014), with, for each classification level, the rules for sharing the supervision of driving between the driver and the automation system or systems. More precisely, this report defines six levels, ranging from level 0 for a vehicle without any automation system, to level 5 for a completely automated vehicle, passing via various degrees of automation for which the share of automation is increased each time and the share of driver responsibility is decreased. Thus:
level 1 corresponds to driving assistance systems relating either to just the longitudinal control of the vehicle (for example the systems known by the acronym ACC or “Autonomous Cruise Control”), or to just the lateral control of the vehicle (for example a system for assisting path holding in a lane, or a system for assisting lane changing used in case of overtaking, of pulling in after overtaking, or of an avoidance procedure);
level 2 corresponds to a so-called “partial automation” level in which the driving assistance system or systems can combine lateral and longitudinal control of the vehicle;
level 3 corresponds to a so-called “conditional automation” level in which the driver is permitted, for a determined time span, and on certain types of roads (for example a highway), to not be attentive to driving. The automated systems appertaining thereto then supervise the lateral and/or longitudinal control of the vehicle, but must yield responsibility to the driver in case of a problem;
level 4 corresponds to complete automation of the vehicle, with the possibility for the driver to delegate the driving, in any situation, and to return to it when he so desires, independently of the duration and of any specific zone;
level 5 corresponds to a completely automated vehicle, with no possibility for the driver to interact.

Levels 0 to 5 according to the SAE correspond substantially to levels 0 to 4 of the American federal agency, NHTSA (“National Highway Traffic Safety Administration”), in charge of road safety.

Because of the aforementioned Article of the Vienna Convention, vehicles of level 3 to 5 are today not permitted by legislation. Levels 0 to 2 are on the other hand permitted since the driver does indeed remain the only supervisor of the driving.

Of interest hereinafter are the projects for future automated vehicles of level 3 according to the SAE or NHTSA Standards, equipped with a conditional automation system. The acceptance of a modification of the Vienna

Convention, which today imposes permanent driver responsibility, entails as a minimum the implementation of a certain number of operating safety procedures and of strategies for allowing the driver to return to the supervision of driving in case of failures of the system.

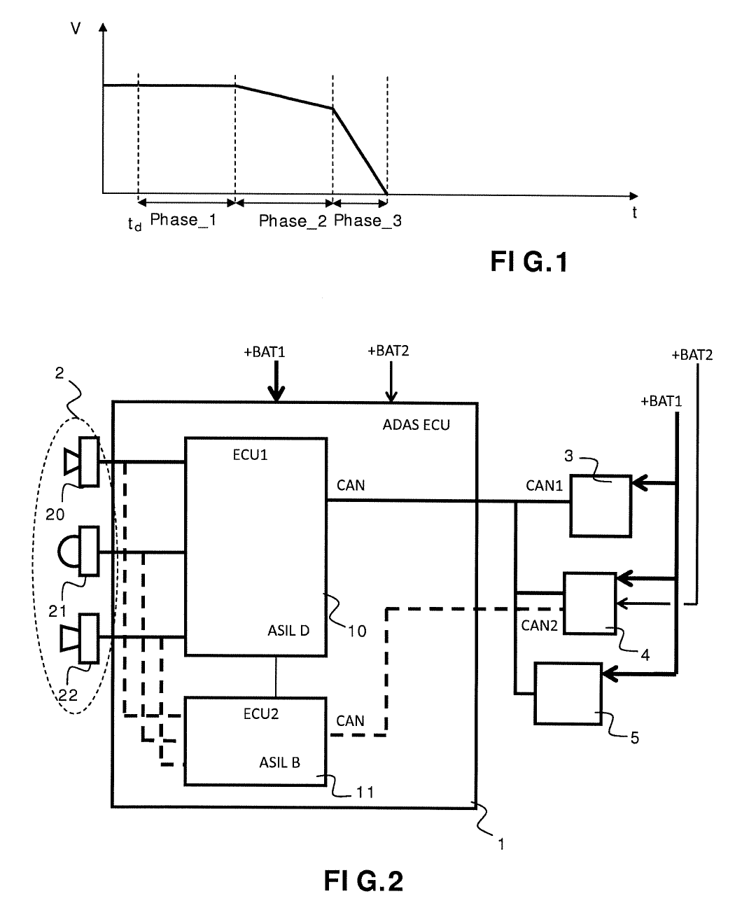

A particularly important strategy relates to the return to the safe state in the case in which the driver were unable to take back control. In this case, and in particular when the vehicle is traveling on a highway at a relatively low speed, it may be sufficient for the system to action a stopping of the vehicle in its travel lane. The various phases generally implemented in application of this strategy are illustrated schematically in FIG. 1 which represents the consequences of this action on the speed of the vehicle as a function of time.

In this FIG. 1, t_{d} represents the instant of detection of a critical failure which requires that the driver theoretically take back control. From this instant, the conditional automation system must admittedly yield control to the driver, but must nonetheless ensure the functionality for a short time span, typically between five and ten seconds, so as to allow the driver to actually take back control of driving. This phase is represented by phase_1 in the figure, and shows that the speed of the vehicle remains constant. If the driver has not reacted on completion of this phase_1, the system begins to brake gently (phase_2 in FIG. 1, also between five and ten seconds). Finally, if the driver has still not reacted on completion of this phase_2, the system instructs heavier braking until the vehicle stops completely. This phase is represented by phase_3 in FIG. 1.

From the functional standpoint, the conditional automation system must, in order to ensure this return to the safe state, be capable of checking what happens in front of the vehicle, of controlling the braking system and the engine control system so as to adjust the speed as a consequence, and of controlling the electronic steering control system so as to remain in one and the same driving lane.

These demands in terms of operating safety necessarily involve using an architecture with a great deal of redundancy, thereby impinging significantly on the cost of these systems. Thus, in accordance with international standard ISO 26262 which defines in particular a classification of criticality of failures according to four levels termed “ASIL A, ASIL B, ASIL C and ASIL D” (the initials standing for Automotive Safety Integrity Level), a level-3 system (conditional automation) must be ASIL D, thus entailing in particular the provision on a vehicle of at least three different technologies of sensors to observe one and the same zone of the environment of the vehicle. A performance rating of good detection is thus ensured, sufficient to be compatible with an ASIL D safety objective, and also an external jammer is prevented from simultaneously rendering the three types of sensors ineffective.

Moreover, in the known architectures, the computer of the system, the connections, typically by CAN bus, allowing the exchanges between, on the one hand, the sensors and this computer, and, on the other hand, the computer of the system and the other computers involved in the strategy for returning to the safe state (braking system computer, engine control computer and steering control computer), as well as the power supplies necessary for the operation of these computers, are generally doubled so as to guarantee operating safety in case of failure related to the computer of the conditional automation system.

The aim of the invention is to propose an architecture of affordable cost for a driving aid system with level-3 conditional automation.

Accordingly, the subject of the present invention is an architecture for driving assistance system with conditional automation able to control automatic emergency stopping of a vehicle, comprising:
a set of sensors of at least three different technologies for observing a zone at the front of a vehicle;
a main computer able to receive, through a first upstream data communication network, information from said set of sensors, and to transmit commands, through a first downstream communication network, to a first computer of an engine control system, to a second computer of a braking system and to a third computer of a steering control system;
a backup computer able to receive, through a second upstream data communication network, information from said set of sensors;
a main power supply source linked to each computer; and
a backup power supply source;
   characterized in that it comprises a second downstream communication network linking only the backup computer to said second computer of the braking system for the transmission of commands, and in that the backup power supply source is linked only to the main computer, to the backup computer and to the second computer of the braking system.

According to other possible features of this architecture:
the first and second upstream and downstream data communication networks are serial data bus networks, preferably CAN networks;
the backup computer is identical to the main computer, in which case they both exhibit the same failure criticality level, preferably a level ASIL D;
as a variant, the backup computer can have a lower failure criticality level than that of the main computer, for example a level ASIL B if the main computer is ASIL D;
the set of sensors comprises for example at least one image sensor, one radar sensor and one laser sensor;
the backup computer can be linked to the main computer, and controlled in such a way as to receive, through the second upstream data communication network, information from said set of sensors only in case of a failure relating to the main computer;
as a variant, the backup computer receives permanently, through the second upstream data communication network, information from said set of sensors, even in the absence of a failure relating to the main computer.

The invention and the various advantages that it affords will be better understood in view of the following description, given with reference to the appended figures in which:

FIG. 1, already described hereinabove, schematically illustrates the phases implemented by a driving aid system with conditional automation in a known strategy for returning to the safe state;

FIG. 2 schematically illustrates an exemplary architecture in accordance with the invention for a driving aid system with conditional automation.

Throughout the disclosure, any driving assistance system of level 3 (SAE/NHTSA) is called a “driving assistance system with conditional automation”.

With reference to FIG. 2, an architecture for a driving assistance system with conditional automation able to control automatic emergency stopping of a vehicle and to guarantee a return to the safe state in accordance with the scenario described in FIG. 1 conventionally comprises a core control module 1 comprising:
on the one hand, a main computer 10 able to receive, through a first upstream data communication network, information from a set 2 of sensors able to observe a zone at the front of the vehicle;
on the other hand, a backup computer 11, linked to the main computer 10, and able to receive, through a second upstream data communication network, information from said set 2 of sensors.

The system has an ASIL D failure criticality level so that, for the set 2, provision is made to use three different technologies for the sensors. Thus, the set 2 can comprise, by way of nonlimiting example, at least one laser sensor 20, one radar sensor 21 and one image sensor 22. The principles of the invention are applicable whatever combination of different technologies (or types) is used.

In FIG. 2, the first upstream network comprises the three connections shown diagrammatically as solid lines between the sensors 20 to 22 and the main computer 10, whilst the second upstream network comprises the three connections shown diagrammatically as dashed lines between these same sensors 20 to 22 and the backup computer 10.

The role of the main computer 10 is to process the information originating from the sensors 20 to 22, and in particular to apply, if necessary, the strategy for returning to the safe state, described with reference to FIG. 1. Accordingly, this main computer 10 is able to transmit the appropriate commands to the various computers of the vehicle that are involved in this strategy, and in particular respectively:
to a first computer 3 of an engine control system,
to a second computer 4 of a braking system; and
to a third computer 5 of a steering control system.

The transmission of the commands is performed through a first downstream communication network, represented by the solid-line connections between the main computer 10 and the three computers 3, 4 and 5.

All the computers described hereinabove are powered by a main power supply, for example a battery (+BAT1 in FIG. 2).

The role of the backup computer 11 is for its part to substitute itself for the main computer 10 in case of failure of the latter.

In accordance with the invention, instead of doubling the downstream communication network between the computers of the system on the one hand, and the three computers 3, 4 and 5, there is provision here to provide a second downstream communication network linking the backup computer 11 just to the second computer 4 of the braking system for the transmission of commands. This second downstream communication network is represented by dashed lines between the backup computer 11 and the braking computer 4.

This type of control is sufficient to also control the steering of the vehicle, in particular at low speed. Indeed, the computers of braking systems are currently all so-called ESP computers (the initials standing for Electronic Stability Program) which can command in a differential manner the braking on each of the wheels, and thus contrive matters so that the vehicle remains in its lane until it stops.

Moreover, to mitigate a possible malfunction of the main power supply +BAT1, a backup power supply source (+BAT2 in FIG. 2), for example a battery, is provided in the architecture. Here again, the architecture is simplified to what is strictly necessary by providing that this backup power supply be used only by the main computer 10, the backup computer 11 and the computer 4 of the braking system alone.

Stated otherwise, an architecture in accordance with the invention consists in making redundant, downstream of the computer of the system, the double power supply and the communication network only for the computer 4 of the braking system.

This results in a cost reduction which in no way limits the guarantee of a return to the safe state in the case in which a driver were unable to take back control.

Within the framework of FIG. 2, it has been considered that the backup computer 11 was linked to the main computer 10, so that it operates in reception and in emission only in case of failure of the main computer.

It is however possible, without departing from the scope of the invention, not to link the two computers 10 and 11. In this case, the two computers 10 and 11 operate in parallel permanently and it is in case of failure of the main computer that the computers 3, 4 and 5 downstream switch to backup mode. One then speaks of “hot redundancy”. This solution allows a faster reconfiguration but consumes more energy.

1. An architecture for driving assistance system with conditional automation able to control automatic emergency stopping of a vehicle, comprising:
a set of sensors of at least three different technologies for observing a zone at the front of a vehicle;
a main computer able to receive, through a first upstream data communication network, information from said set of sensors, and to transmit commands, through a first downstream communication network, to a first computer of an engine control system, to a second computer of a braking system and to a third computer of a steering control system;
a backup computer able to receive, through a second upstream data communication network, information from said set of sensors;
a main power supply source linked to each computer;
a backup power supply source; and
a second downstream communication network linking only the backup computer to said second computer of the braking system for the transmission of commands, and in that the backup power supply source is linked only to the main computer, to the backup computer and to the second computer of the braking system.

2. The architecture as claimed in claim 1, wherein the first and second upstream and downstream data communication networks are serial data bus networks.

3. The architecture as claimed in claim 2, wherein the first and second upstream and downstream data communication networks are CAN networks.

4. The architecture as claimed in claim 1, wherein the backup computer is identical to the main computer.

5. The architecture as claimed in claim 1, wherein the backup computer has a lower failure criticality level than that of the main computer.

6. The architecture as claimed in claim 5, wherein the failure criticality level of the main computer is ASIL D, and the failure criticality level of the backup computer is ASIL B.

7. The architecture as claimed in claim 1, wherein said set of sensors comprises at least one image sensor, one radar sensor and one laser sensor.

8. The architecture as claimed in claim 1, wherein the backup computer is linked to the main computer, and controlled in such a way as to receive, through the second upstream data communication network, information from said set of sensors only in case of a failure relating to the main computer.

9. The architecture as claimed in claim 1, wherein the backup computer receives permanently, through the second upstream data communication network, information from said set of sensors, even in the absence of a failure relating to the main computer.
